(19) United States
(12) Patent Application Publication
(10) Pub. No.: US 2010/0200743 A1
(43) Pub. Date: Aug. 12, 2010

(54) WELL COLLISION AVOIDANCE USING DISTRIBUTED ACOUSTIC SENSING

(76) Inventors: Larry Dale Forster, Metairie, LA (US); Frederick Henry Kreisler Rambow, Houston, TX (US); Dennis Edward Dria, Houston, TX (US); Lisa Shava Grant, New Orleans, LA (US); Charles Louis Collins, New Orleans, LA (US)

Correspondence Address: SHELL OIL COMPANY, P O BOX 2463, HOUSTON, TX, 772522463, US

(21) Appl. No.: 12/579,939

(22) Filed: Oct. 15, 2009

Related U.S. Application Data
(60) Provisional application No. 61/150,842, filed on Feb. 9, 2009.

(51) Int. Cl. G01V 8/00; E21B 47/02

(52) U.S. Cl. 250/254; 33/302

(57) ABSTRACT

A method for obtaining location information about a well as it is being drilled through a subsurface, comprises: providing at least one fiber optic cable deployed in a borehole within acoustic range of the well, the proximal end of the cable being coupled to a light source and a photodetector, the fiber optic cable being acoustically coupled to the subsurface formation so as to allow acoustic signals in the subsurface to affect the physical status of the cable, providing an acoustic source in the well, transmitting at least one light pulse into the cable, receiving at the photodetector a first light signal indicative of the physical status of at least one first section of the cable. The first section is selected so that the first light signal provides information about the position of the acoustic source, and outputting at least the information to a display.

### RELATED CASES

This case claims priority to U.S. provisional application 61/150842, filed Feb. 9, 2009 and entitled “Method Of Detecting Fluid In-Flows Downhole,” which is incorporated herein by reference.

### FIELD OF THE INVENTION

The invention relates to the use of fiber optic cables to provide a system of distributed acoustic sensors that can be used to provide information about the position of various subsurface objects and in particular to locate existing wellbores during drilling.

### BACKGROUND OF THE INVENTION

Existing wells on production at an offshore platform or onshore well pad are under significant risk when a new well is drilled, or an existing well is re-drilled, from the same facility or one in the vicinity. The risk is due to the possibility of collision of the drill bit or other drilling apparatus in the new well with the casing and/or well tubing of the existing wells. Such a collision would result in damage to equipment and to the wellbores themselves, which is costly to repair (and also introduces further risk), and could result in an undesired release of hydrocarbons, possibly without effective means to control. Existing tools and techniques for avoiding collision are based on measurement-while-drilling and other surveys, which may not have sufficient accuracy to prevent collision. Due to the uncertainty and the significant risk, wells that are adjacent to a new or redrilled well are typically shut in and monitored during the drilling operation, which reduces the risk, but has economic impact on the producing facility.

A reliable method for locating the position of a wellbore with respect to adjacent wellbores, while drilling is underway, would not only reduce the significant risk described above, but also may allow drilling of wells which might not have been deemed possible or prudent without a suitable method, and may increase the efficiency (drilling rate) of the drilling operation.

Acoustic positioning/imaging has extensive prior utilization in fluid media and in soil-based media (e.g., sub-bottom acoustic profiling), but at lower spatial resolution than is required for this application. On the other hand, the penetration capability of devices/techniques with sufficient resolution (e.g., scanning sonar) is insufficient for the dimensions/scale of this application. Longer range devices/techniques (e.g., acoustic geo-steering, seismic) while having sufficient range, have insufficient resolution.

For these reasons, it is desirable to provide an acoustic monitoring system that is relatively inexpensive to acquire, deploy, and maintain, and which allows precise real-time detection of a drilling operation and/or determination of the precise trajectory of an existing well.

### SUMMARY OF THE INVENTION

The present invention provides an acoustic monitoring system that is relatively inexpensive to acquire, deploy, and maintain, and allows real-time detection of a drilling operation and/or determination of the precise trajectory of an existing well.

Because of the adaptability and agility of the present system, it can be used to efficiently collect information in various ways. For example, the present system can be deployed in a plurality of existing wells and used to detect the advance of a new well being drilled or re-drilled in the vicinity. In other embodiments, the present system can be deployed in a plurality of existing wells and used in conjunction with one or more active acoustic sources to determine the trajectory of an existing well.

One preferred embodiment of the invention provides a method for obtaining location information about a well as it is being drilled through a subsurface by a) providing at least one optical fiber or fiber optic cable deployed in a borehole within acoustic range of the well being drilled, the fiber optic cable having a proximal end and a remote end, the proximal end being coupled to a light source and to a photodetector, the fiber optic cable being acoustically coupled to the subsurface formation so as to allow acoustic signals in the subsurface to affect the physical status of the cable, b) providing an acoustic source in the well that is being drilled; c) transmitting at least one light pulse into the cable; d) receiving at the photodetector a first light signal indicative of the physical status of at least one first section of the cable, wherein said first section is selected so that the first light signal provides a first item of information about the position of the acoustic source; and e) outputting at least the first item of information to a display. The method may further include the step of determining whether the first item of information meets a predetermined criterion and altering the trajectory of the well that is being drilled if the criterion is met.

In some embodiments, at least one optical fiber or fiber optic cable is provided in each of a plurality of boreholes within acoustic range of the well being drilled and the information collected from the plurality of fiber optic cables is used to triangulate the position of the acoustic source.

The method may further include the step of using the acoustic data to determine the location of at least one of the existing boreholes. The method may further include repeating at least steps c) through e) over time.

The acoustic source may be active drill bit, or may be a modulated or un-modulated source other than a drill bit.

### BRIEF DESCRIPTION OF THE DRAWINGS

For a more detailed understanding of the invention, reference is made to the accompanying drawings wherein:

FIG. 1 is a schematic plan view of an environment in which the invention could be used; and

FIG. 2 is schematic side view of an environment in which the invention could be used.

As used herein, the term “area” refers to an areal amount of the surface or subsurface that is sensed by a cable, section of optical fiber or section of fiber optic cable. For a cable at the surface, the area is determined at the surface, with the boundaries of the area being established by an imaginary line drawn on the surface so as to enclose the cable or section of cable. In the case of a subsurface cable, the area is determined on an imaginary plane parallel to the surface, on which the path of a subsurface cable is projected, with the boundaries of the area being established by an imaginary line drawn on the plane so as to enclose the projection the cable or section of cable on the plane.

### DETAILED DESCRIPTION OF A PREFERRED EMBODIMENT

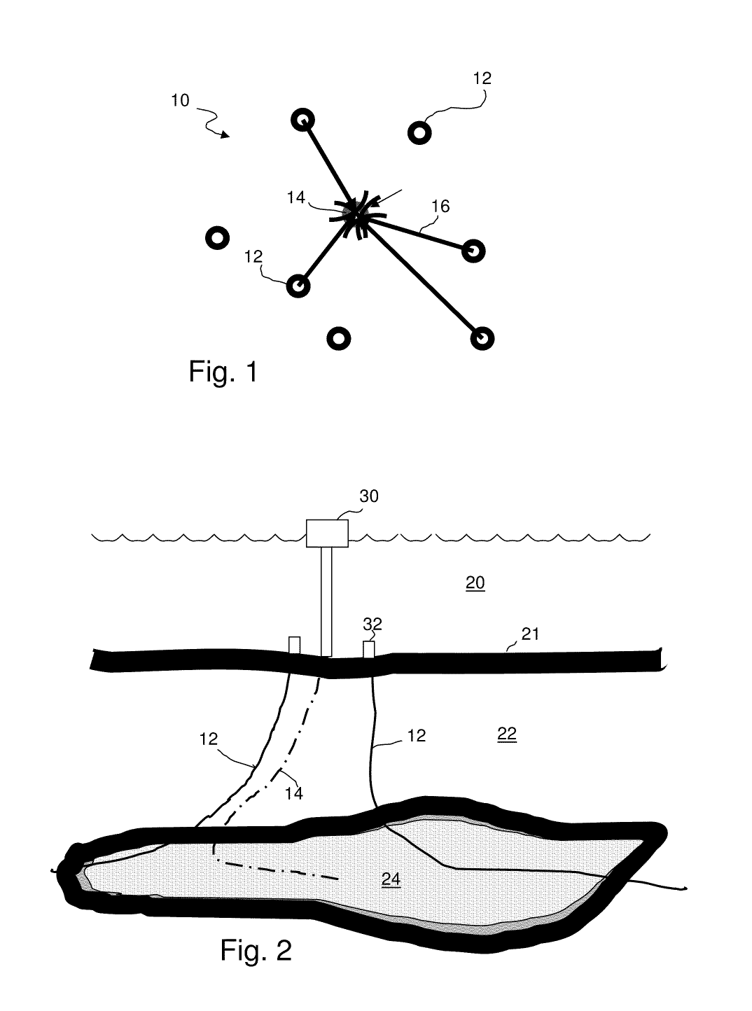

Referring initially to FIGS. 1 and 2, an offshore environment 10 includes a plurality of existing wells 12 and a new well 14 (shown in phantom) typically located in some depth of water 20. The wells extend through the seafloor 21 and into a subsurface 22. Subsurface 22 includes a target formation 24. As shown in FIG. 2, each well extends from the seafloor along a desired trajectory. New well 14 will typically be drilled from a platform 30, or the like, as is known.

In the illustrated system, it is desired to drill well 14 along the trajectory shown, in order to maximize contact with the target formation 24 and therefore maximize production from well 14. Wells 12 are close enough to the desired trajectory of well 14 that there may be a risk that well 14 will intersect the trajectory of one of wells 12 if the trajectory of well 14 is not adequately guided during drilling or if the trajectory of wells 12 are not known with sufficient accuracy or certainty.

It has been found that by monitoring acoustic signals in one or more wells 12, useful real-time information about the trajectory of well 14 can be obtained. Specifically, by positioning distributed acoustic sensors in one or more of existing wells 12 as described in detail below, acoustic signals generated in well 14 and received by the distributed acoustic sensors can be processed to give information about well 14. For instance, noise generated by the drill bit as it drills well 14 is transmitted from well 14 through the subsurface to wells 12. Alternatively, one or more other acoustic sources can be placed in well 14 and used to send acoustic signals to sensors in wells 12.

Distributed acoustic systems that are suitable for use in the present invention are known. By way of example only, a single cable or optical fiber may be deployed into each existing well 12. Each cable contains preferably an optical fiber connected to a signal processing center (not shown) at wellhead 32, which is preferably in communication with the drilling operation via an umbilical or the like in the case of subsea wells, or directly to the drilling operation in the case of a well-head on the platform, drilling vessel or production vessel. The signal processing center includes a light source arranged to introduce an optical signal into the proximal end of cable and a photodetector arranged to detect radiation that has been reflected or backscattered within cable back toward the input end and to generate an output signal in response to the detected radiation.

A light source may be configured to provide light pulses into one or more optical fibers or fiber optic cables, while a photodetector is preferably provided for each fiber or cable but a single photodetector may be connected to one or more fibers via a multiplexing device. An optical fiber or fiber optic cable is preferably provided in each existing well 12 that is at risk of intersection, but useful information about well 14 can be gained even if fewer cables are used or less than all existing wells are provided with sensors. In some instances, a single cable in a single existing well may be used.

Each fiber optic cable is preferably acoustically coupled to the subsurface formation, so that acoustic signals travelling through the subsurface can affect the physical status of the cable and produce optically detectable changes. By altering the physical status of the cable, the acoustic signals create a localized or semi-localized change in the backscattering properties of the cable, which in turn alter the backscattered or reflected light that is sensed by the photodetector. Using techniques that are known in the art, the optical signals received from the cable can be used to extract information about the position and magnitude of the incoming acoustic signal(s). According to the invention, this information is used in turn to estimate the location of the acoustic source. As mentioned above, the source may be an active drill bit or any other acoustic source.

Various techniques can be used to achieve the necessary degree of acoustic coupling. In one embodiment, the fiber optic cable is lowered into an existing well 12 and is unrestrained in the wellbore, where it is typically surrounded by liquid. In other embodiments, the fiber optic cable can be clamped to the inside or outside of casing or production or injection tubing at intervals, or affixed along its length by means of a suitable adhesive or the like. In still other embodiments, the fiber optic cable can be positioned on the outside of the casing so that it is acoustically coupled to the formation via the cement in the annulus. In still other embodiments, fiber optic cable can be included in various downhole tools and well-completion components, such as sand screens, slotted or perforated liners, other sand-control components and telescoping joints, or included in other tools typically used for well intervention such as coiled tubing, composite hollow or solid tubes, braided cable, communication cables for conveying logging tools or slick-line cables, or included in such or similar devices which are conveyed into the existing well specifically for the purpose of obtaining the acoustic information needed. In each case, the requisite degree of acoustic coupling may depend on the nature and completion state of each well and the nature of the acoustic source and signals.

In some embodiments, the light source is a long coherence length phase-stable laser and is used to transmit direct sequence spread spectrum encoded light down the fiber. Acoustic vibrations or other disruptions cause small changes to the fiber, which in turn produce changes in the backscattered light signal. The returning light signal thus contains both information about the acoustic vibration and location information indicative of where along the fiber sound impacted the fiber. The location of the acoustic signal along the fiber can be determined using the spread spectrum encoding, which uniquely encodes the time of flight along the length of the fiber. Because the fiber can be selectively “interrogated,” the present system has the ability to be both adaptable and/or programmable. The use of fiber optics enables varying of the spatial resolution, timing, sensitivity, and location of the acoustic sensing performed by the fiber separately or together and in real time. For this reason, the present system can be referred to as an agile system.

The fiber or cable may be double-ended, i.e. may loop back or include a turn-around sub at the point of deepest deployment so that both ends of the cable are accessible to the source, or it may be single-ended, with one end at the source and the other end at a point that is remote from the source. The length of the cable can range from a few meters to several kilometers, or even hundreds of kilometers. In either case, measurements can be based solely on backscattered light, if there is a light-receiving means only at the source end of the cable, or a light receiving means can be provided at the second end of the cable, so that the intensity or other properties of light at the second end of the fiber optic cable can also be measured.

Using optical time domain reflectometry (OTDR) technology, it is possible to determine an amount of backscattered light arriving from any point along the fiber optic cable. Although the duration of the light pulse determines the lower limit on the spatial resolution, the resulting signal can be used to extract information at any larger interval. This can be accomplished by dividing the backscattered light signal into a series of bins in time. The data within each bin is summed to give information about the average strain on the length of fiber between the endpoints of the bin. These bins can be made arbitrarily large to sample longer sections of the fiber. The bins may be equally sized and continuously spread over the entire length of the fiber with the end of one bin becoming the start of the next, but if desired, the size and position of each bin, in addition to the spacing between consecutive bins, can be tailored to yield the optimum desired spatial sampling resolution and sensitivity.

Thus, by time-gating the received backscattered signal, each fiber optic cable can be treated as a plurality of discrete, distributed acoustic “sensors” (DAS), with each sensor corresponding to a section of cable. The time-gating can be controlled to produce sections/sensors that are as long or as short as desired. For example, one portion of the cable can sense at high resolution, using relatively short sections of cable having lengths L-₁, while another portion of cable 22 can sense at a lower resolution, using relatively long sections of cable having lengths L₂. In some embodiments, higher-resolution section length L₁ preferably falls within the range 0.1 to 10 m and lower-resolution section length L₂ preferably falls within the range 10 to 1000+m.

One example of a suitable DAS technology is a system called Blue Rose. This system exploits the physical phenomenon of Rayleigh optical scattering, which occurs naturally in optical fibers used traditionally for optical time domain reflectometry (OTDR) techniques. Blue Rose detects backscattered light and uses the signal to give information about acoustic events caused by activities near the cable. The sensor is a single strand of single-mode optical fiber with an elastomeric, polymeric, metallic, ceramic, or composite coating that is buried in the ground at a depth of approximately nine inches. Alternatively, coherent OTDR (C-OTDR) processes can be used to obtain similar acoustic information from an optical system, as disclosed in US Application No. 20090114386.

In other embodiments, an optical system such as that described in U.S. application Ser. No. 2008277568 can be used. That system uses pulsed pairs of light signals that have different frequencies and are separated in time. If used, such a system allows processing of the signal to be carried out more easily and with a greater signal-to noise ratio than is the case if radiation of a single frequency backscattered from different positions along the length of optical fiber is used to generate a signal at a photodetector by interferometery.

The flexible sensing provided by DAS allows maximum resolution sampling along intervals of high interest without over-sampling regions of lower interest. In some embodiments, data can be collected from a DAS cable in a manner that gives relatively high resolution data from one portion of the cable, such as, for example, the portion that lies in the section of well 12 that is nearest to well 14. If a DAS cable is permanently installed in a well 12, the ability to change which portion of the cable senses at high resolution may be advantageous, if well 14 remains close to well 12 over a significant distance, or if a second new well 14′ is later drilled and approaches a different portion of well 12 than was approached by well 14.

Because it allows very high resolution in all or selected parts of the DAS cable, the present agile system provides the ability to collect data in a manner that allows for much greater precision that has heretofore been possible. In addition, by repeating the sensing over time and comparing the resulting information, it will be possible to determine whether a predetermined criterion is met, such as a desired minimum spacing between the wells, and to alter the course of the new well so as to avoid and intersection.

While the invention can be used in a single “listening” well 12, preferred embodiments include at least two, and more preferably at least three such wells, with at least one DAS fiber or cable in each. If more than one fiber or cable is provided in a single well, the data therefrom can be used to reduce signal to noise and/or to allow selection of better data from the cable or cable portion that is better coupled to the environment.

Regardless of whether there is more than one DAS fiber or cable in a well, the data from a plurality of wells can be combined to give a more accurate determination of the location of the acoustic source relative to each set of sensors. In some embodiments, the degree of attenuation of the signal as it is received at each of a plurality of sensors can be used as an indication of distance and thus form the basis for determining the location of the source. Alternatively, if the acoustic source is modulated, either deliberately or coincidentally, randomly or predictably, the transit time of each acoustic modulation from the source to each sensor can form the basis for a triangulation calculation. Typically, multiple distance measurements are taken and then used to compute wellbore location using a triangulation method, as illustrated in FIG. 1, or using other positioning algorithms. In still other embodiments, it may be desirable to provide a modulated signal in addition to any inherent acoustic signals, in order to facilitate the multiplexing of signals from several cables.

When double-ended fibers are used, one end of the fiber in one well to a fiber can be connected to an end of the fiber in an adjoining well, effectively collecting multi-well DAS data in a single acquisition without the need for multiple light sources, photodetectors or multiplexors/switches.

Likewise, it may be desirable to include additional acoustic sources and/or acoustic sensors at the top of one or more wells. Data collected from such sensors or by using such sources can be used advantageously in combination with data gathered from the downhole DAS sensors. For example, when one or more acoustic sources are provided at the surface, either at the wellheads or elsewhere, data from DAS cables in one or more wells 12 can be used in combination with knowledge about the location of those sources to define the locations of wells 12 relative to the source(s).

In one embodiment, the signal processing center at wellhead 32 continuously samples the amount of backscattered light at each section along the fiber optic cable and compares the backscattered light intensity with a previous sample to determine whether a sufficient change in backscattered light intensity has occurred and if so, at which point(s). This approach can generate volumes of data that are impractical or difficult to handle, particularly if the spatial resolution is relatively high. Thus, in another embodiment, sensing and location of backscattered light in certain sections of the cable may be actuated by a detection of a change in light intensity from one or more monitoring sections. Because it allows the storage of smaller volumes of data, this approach may be advantageous in cases where there are limitations on the volume of data that can be collected, transmitted, or processed.

The present adaptable monitoring system can record acoustic signals generated by seismic energy sources that are on the surface, in the water, or in boreholes. The monitoring systems that would result from such combination of sources and adaptable sensor networks includes all known geometries, such as 2D or 3D surface seismic, 2D or 3D ocean bottom or marine seismic, 2D or 3D VSP seismic, cross-well seismic, microseismic monitoring in boreholes or at surface from hydraulic fracturing or EOR processes, etc Likewise, the present system can be used to monitor all propagation modes, including reflection and refraction (shear and compressional) waves, surface waves, Love waves, Stonely waves, and other guided modes. When the fiber optic cables are deployed downhole in horizontal wells, such configurations enable the use of virtual source seismic techniques, which are useful for reservoir monitoring under complex overburden.

While the present invention has been described in terms of the preferred embodiments, it will be understood that various modifications thereto can be made without departing from the scope of the invention, as set out in the claims that follow. By way of example only, one of skill in the art will recognize that the number and configuration of cables and sensors, the sampling rate and frequencies of light used, and the nature of the optical fiber, along with its coatings and cable, coupling devices, light sources and photodetectors can all be modified. Likewise, the acoustic sensors and/or detectors may be placed either above or below the soil/media. The invention is suitable for, but not limited to, use in clustered drilling centers where a number of wells originate from a wellbay or pad, in a closely spaced pattern (˜15 ft. spacing) at a ground or mudline datum, penetrate the soil/media near vertically and then deviate (over hundreds or thousands of feet) to their subsurface objectives. Acceptable water depths range from minimally shallow to 10,000 ft. or greater. Finally, it will be understood that the methods described herein can be used to advantage in instances where it is desired to converge a new well with an existing well, rather than to maintain distance between wells. Finally, the methods described herein can be used to advantage in combination with other, known techniques, such as but not limited to magnetic field sensing.

What is claimed is:

1. A method for obtaining location information about a well as it is being drilled through a subsurface, comprising:
a) providing at least one optical fiber or fiber optic cable deployed in at least one borehole within acoustic range of the well being drilled, or in the well being drilled, or laid on the seafloor within range of the well being drilled, said fiber or fiber optic cable having a proximal end and a remote end, said proximal end being coupled to a light source and to a proximal photodetector, said fiber optic cable being acoustically coupled to the subsurface formation so as to allow acoustic signals in the subsurface to affect the physical status of the cable;
b) providing an acoustic source in the well that is being drilled, or in one or more boreholes within range of the well being drilled, or on the seafloor within range of the well being drilled;
c) transmitting at least one light pulse into the fiber or cable;
d) receiving at the photodetector a first light signal indicative of the physical status of at least one first section of the cable, wherein said first section is selected so that the first light signal provides a first item of information about the position of the acoustic source;
e) outputting at least the first item of information to a display.

2. The method according to claim 1, further including the step of determining whether the first item of information meets a predetermined criterion and altering the trajectory of the well that is being drilled if the criterion is met.

3. The method according to claim 1 wherein at least one fiber or fiber optic cable is provided in each of a plurality of boreholes within acoustic range of the well being drilled, or in the well being drilled, or on the seafloor within range of the well being drilled, steps c) and d) are repeated in each cable, and the information collected from the plurality of fiber optic cables is used to triangulate the position(s) of the acoustic source or sources.

4. The method according to claim 3, further including the step of using the first item of information to determine the location of at least one of said boreholes.

5. The method according to claim 3, further including the step of measuring the degree of attenuation of the acoustic signal as it travels to each cable section.

6. The method according to claim 3, further including the step of measuring the tansit time of the acoustic signal as it travels to each cable section.

7. The method according to claim 1, further including repeating at least steps c) through e) over time.

8. The method according to claim 1 wherein the acoustic source is an active drill bit.

9. The method according to claim 1 wherein the acoustic source is modulated.

10. The method according to claim 1 wherein the acoustic source provides a randomly varying frequency spectrum and power output.
